(19) United States
(12) Patent Application Publication
(10) Pub. No.: US 2008/0192666 A1
(43) Pub. Date: Aug. 14, 2008

(54) METHOD AND SYSTEM FOR DYNAMICALLY UTILIZING A PEER NETWORK TO EXTEND BATTERY LIFE

(75) Inventors: Patrick D. Koskan, Lake Worth, FL (US); Charles B. Swope, Coral Springs, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/673,748

(22) Filed: Feb. 12, 2007

(51) Int. Cl. G08C 17/00; H04B 1/38

(52) U.S. Cl. 370/311; 455/574

(57) ABSTRACT

A system (100) and method (300) for utilizing peer networks to extend a battery life of a mobile device in a wide area network (WAN) using a Wireless_Local Area Network (WLAN) is provided. The method can include monitoring (302) a power-level of the mobile device, determining (304) if the power-level is below a pre-determined threshold, identifying (306) peers to serve as transmit proxies in view of the power-level, and switching from a high-power transceiver (206) to a low-power transceiver (208) to reduce power consumption. The mobile device can communicate with the peers using a low-power transceiver in the WLAN to transmit communication data within the WAN.

### FIELD OF THE INVENTION

The present invention relates to wireless communication systems and, more particularly, to extending battery power of a mobile device in a wireless communication system.

### BACKGROUND

In today's managed radio network systems, which utilize two way radios and/or other mobile radios devices, the longevity of a radio is limited by it's battery power. That is, under normal daily usage, without recharging, the radio will eventually lose battery power which renders the radio unusable. It is a generally accepted practice to recharge the mobile device or replace the battery when the power runs low. However, in certain situations, a user may be in a critical or emergency situation. The user may need the device to immediately place a phone call or send data. In such circumstances the user cannot afford the time to recharge the battery, or perhaps even change out the battery for a new battery. Moreover, the user may not be aware that the mobile device is low in power until the call is made. As an example, in public safety service, a user may need to immediately place an emergency dispatch call. The ability to acquire and maintain continuous communication (without drops due to battery limitations) can be critical in the public safety environment. Likewise in the public sector, the consequences of acquiring and maintaining continuous communications can be critical to a user needing to make_an important call. In certain situations, a user can borrow another user's radio to make a call. However, this is a cumbersome task that is infringing to the other users. The only current options available to the user are to recharge the battery, replace the battery, or place a call using another mobile device. A need therefore exists for extending battery life to alleviate these situations.

### SUMMARY

One embodiment is a system for utilizing peers to extend a battery life of a mobile device. The system can include a wireless infrastructure that provides communication coverage to mobile devices over a wide area, at least one mobile device within the wireless infrastructure that switches from a high-power transceiver for communicating in the wireless infrastructure to a low-power transceiver for communicating with a peer when a power-level of a battery of the at least one mobile device falls below a predetermined threshold, and a peer network communicatively coupled to the mobile device having at least one peer for providing proxy services to the mobile device when the power-level falls below the predetermined threshold. The peer can provide transmit or receive communication with the at least one mobile device to extend a battery life of the mobile device. The infrastructure can identify a location of the peers using a location technology such as global positioning system (GPS) and report the location of the peers to the mobile device to identify peers available for serving as a proxy using low-power communication. Peers within the peer network can communicate amongst one another and the mobile device using low-power and low-range communication such as Bluetooth, Zigbee, Ultra-Wide Band (UWB), a IEEE 802.11 or 802.16x communication, or other wireless means.

Another embodiment is a mobile device having extended battery life capabilities. The mobile device can include a battery that provides power to the mobile device for transmitting and receiving communication signals, a monitor operatively coupled to the battery that monitors a power level of the battery, a first transceiver operatively coupled to the battery that provides long-range communication, a second transceiver operatively coupled to the battery that provides short-range communication, and a processor operatively coupled to the monitor, the first transceiver, and the second transceiver. The processor can evaluate the power level and switch to the second transceiver to transmit communications to a peer device within short range communication if the power level is below a predetermined threshold. In one arrangement, the first transceiver can be a Wide Area Network (WAN) transceiver using high power consumption over a wide-area providing coverage within at least one 1 kilometer. The second transceiver can be a Wireless Local Area Network (WLAN) transceiver or Personal Area Network (PAN) transceiver using low power consumption over a short-area providing communication coverage within at least 100 meters. The mobile device can include a location unit to identify a location of the mobile device. In such regard, the mobile device can identify the locations of peers that are within short range communication for extending a battery life of the mobile device.

Yet another embodiment is a method for utilizing peer networks to extend battery life of a mobile device. The method can include monitoring a power-level of the mobile device, determining if the power-level is below a pre-determined threshold, identifying peers to serve as transmit proxies in view of the power-level, and switching from a high-power transceiver to a low-power transceiver to reduce power consumption. The mobile device can communicate with the peers using the low-power transceiver to transmit communication data. The method can further include identifying peers to serve as receive proxies, and receiving communication data from the peers. In one aspect, available power levels of the peers to act as transmit proxies can be determined, and the peers can be ranked and selected by available power levels, security levels, permissions, and routing paths.

In one aspect, the method can include predicting a remaining power and usage rate from the power-level, and triggering a battery extension mode based on the remaining power and usage rate. Once in battery extension mode, the mobile device can alert the first transceiver of the low-battery indication, and request prioritization to identify and utilize nearby peers to transmit and receive payload by proxy. The step of identifying peers can further include determining a location of a peer with respect to a location of the mobile device, and determining whether the location of the peer is within a wireless communication range of the second transceiver. The mobile device can establish short range communication with peers that are within low-power wireless communication range. A visual or auditory cue can also be provided to indicate that a peer is providing proxy services to the mobile device. The mobile device can prioritize the peers based on peer battery levels, peer resource use, wide area network request, wide area network rerouting, or peer security. Peers can also be dynamically selected based on permissions of peers to serve as proxies for the mobile device.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a wireless communication system for extending a battery life of a mobile device using peer networks in accordance with an embodiment of the present invention;

FIG. 2 is a block diagram of a mobile device having extended battery life capabilities in the network shown in FIG. 1;

FIG. 3 is a diagram for using a peer to proxy transmit communications for a mobile device to extend battery life in accordance with an embodiment of the present invention;

FIG. 4 is a diagram for using a peer to proxy transmit and receive communications for a mobile device to extend battery life in accordance with an embodiment of the present invention;

FIG. 5 is a method for extending battery life of a mobile device using peer networks in accordance with an embodiment of the present invention;

FIG. 6 is a method for identifying peers in accordance with an embodiment of the present invention;

FIG. 7 is a method for ranking peers in accordance with an embodiment of the present invention;

FIG. 8 is an exemplary table for ranking peers by power level in accordance with an embodiment of the present invention;

FIG. 9 is an exemplary table for ranking peers by security level in accordance with an embodiment of the present invention;

FIG. 10 is an exemplary table for ranking peers by permissions in accordance with an embodiment of the present invention;

FIG. 11 is a flow chart for extending a battery life of a mobile device using a peer in accordance with an embodiment of the present invention;

FIG. 12 is a flow diagram for the exchange of communication between a mobile device and a peer in accordance with an embodiment of the present invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processing” can be defined as number of suitable processors, controllers, units, or the like that carry out a pre-programmed or programmed set of instructions. The terms “program,” “software application,” and the like as used herein, are defined as a sequence of instructions designed for execution on a computer system.

The term “proxy” can be defined as a device or system that provides services, such as transmit and receive operations, to another device. The term “peer” can be defined as a mobile device that is within a local area of another mobile device. The term “location” can be defined as a physical location of a mobile device. The term “power-level” can be defined as the amount of energy per unit time in a battery. The term “high-power transmit” can be defined as current drain approximating 1500 mA. The term “high-power receive” can be defined as current drain approximating 250 mA. The term “low-power transmit” can be defined as current drain approximating 30 mA. The term “low-power receive” can be defined as current drain also approximating 30 mA.

Briefly, embodiments of the invention are directed to a method to extend a mobile device's battery life by utilizing peers that are within a range of the mobile device as main network communication proxies. The mobile device can identify peers within a local area to proxy communications when a battery power of the mobile device is low. The communication between the mobile device and the peers uses low power communication, such as Bluetooth or Zigbee, which extends a battery life of the mobile device. The peers can send and/or receive communications data on behalf of the mobile device given that the peers have sufficient spare power to support the communication. In one arrangement, a location of the peers relative to the mobile device can be identified by location technologies such as global positioning system. The peers can be selected based on available power level, security level, permissions, or routing paths.

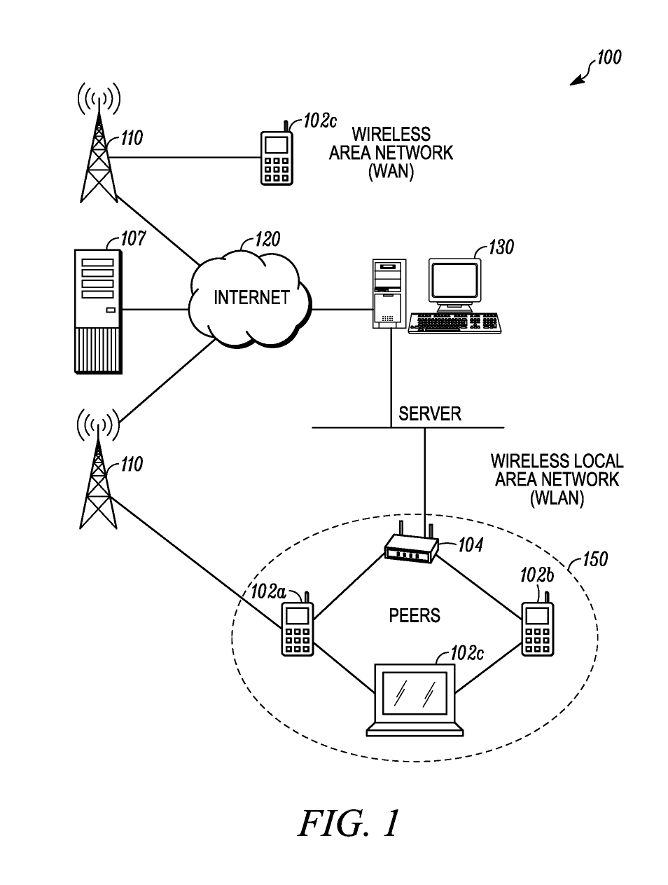

Referring to FIG. 1, a mobile communication system 100 is shown. The mobile communication system 100 can include one or more base receivers 110, one or more routers 107, one or more servers 130, one or more access points 104, and one or more mobile devices 102. The mobile devices 102 are also referred to as peers. The mobile communication system 100 can provide wireless connectivity over a radio frequency (RF) communication network such as a Wide Area Network (WAN) and/or a Wireless Local Area Network (WLAN). The WAN can include one or more base receivers 110 providing communications to one or more mobile devices 102-a through 102-c. For example, mobile device 102a can communicate with mobile device 102b over a RF connection through the base receivers 110. Communication within the mobile communication system 100 can be established using a wireless, copper wire, and/or fiber optic connection using any suitable protocol (e.g., TCP/IP, HTTP, etc.). In particular, the WAN provides wide area coverage over a few kilometers, and allows the mobile devices 102 to communicate with one another through the base receivers 110 over long distances. In one arrangement, a mobile device 102 can communicate with a base receiver 110 using a standard communication protocol such as CDMA, GSM, or OFDM.

In another arrangement, the base receivers 110, can connect the mobile devices 102 to the Internet 120 over a packet switched link. The WAN can include, for example, a core local area network (LAN), and a plurality of servers and gateway routers 107 to provide network nodes with access to other networks, such as other ad hoc networks, peer-to-peer networks, or the public switched telephone network (PSTN) for connecting to the Internet 120. The mobile communication system 100 can include a plurality of fixed routers 107 for routing data packets between other nodes 102, 104, 107, or other routers. It is noted that for purposes of this discussion, the nodes discussed above can be collectively referred to as “nodes 102, 104 and 107”, or simply “nodes”. As can be appreciated by one skilled in the art, the nodes 102, 104 and 107 are capable of communicating with each other directly, or via one or more other nodes 102, 104 or 107 operating as a router or routers for packets being sent between nodes.

The mobile device 102a can also connect to the Internet 120 over the WLAN 150. Wireless Local Access Networks (WLANs) provide wireless access to the mobile communication system 100 within a local geographical area. As an example, the WLAN 150 can provide communication up to 100 meters using a typical IEEE 802.16 communication link. The WLAN can provide communication to greater ranges depending on the communication technology employed and is not limited to any particular range. The mobile communication system 100 can include the server 130 having at least one access point 104, for connecting the mobile devices 102a and 102b to the internet 120. The WLAN can complement loading on base receivers of a cellular system, so as to increase capacity. In general, WLANs are typically composed of a cluster of Access Points (APs) 104 also known as base stations. A mobile communication device 102 can communicate with other WLAN stations such as the laptop 102c within the base station area 150. In typical WLAN implementations, the physical layer uses a variety of technologies such as 802.11b or 802.11 g WLAN technologies. The physical layer may use infrared, frequency hopping spread spectrum in the 2.4 GHz Band, or direct sequence spread spectrum in the 2.4 GHz Band. The mobile device 102a can send and receive data to the server 130 or other remote servers on the mobile communication environment 100.

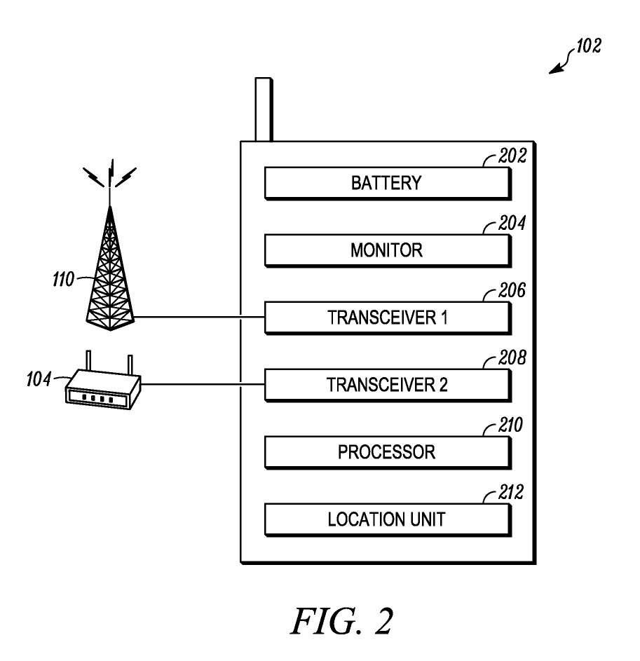

Referring to FIG. 2, a mobile device 102 is shown. The mobile device 102 can be a radio, a cell phone, a personal digital assistant, a laptop, a portable music player, or any other suitable mobile communication device. The mobile device 102 can include a battery 202 that provides power for transmitting and receiving communication signals, a monitor 204 operatively coupled to the battery that monitors a power level of the battery 202, a first transceiver 206 operatively coupled to the battery 202 that provides long-range communication, a second transceiver 208 operatively coupled to the battery 202 that provides short-range communication, and a processor 210 operatively coupled to the monitor 204, the first transceiver 206, and the second transceiver 208. The mobile device 102 can also include a location unit 212, such as a global positioning system (GPS) device, for identifying a physical location of the mobile device.

Notably, the monitor 204 can determine when the power level of the battery 202 falls below a predetermined level. In response, the mobile device 102 can identify a peer within close proximity of the mobile device 102a based on location information provided by the location unit 212 of each peer. For example, the mobile device 102 can receive information regarding the location of peers from the base receiver 110 using the first transceiver 206 or directly from the peers using the second transceiver 208 from location information provided by the location unit 212. The processor 210 can then switch to the second transceiver 208 for low-power communication with a peer when the peer is within short range communication of the mobile device. The peer can proxy transmit and receive communications on behalf of the mobile device 102 to extend a battery life of the mobile device 102.

Briefly, the mobile device 102 uses the first transceiver 206 as the primary means for transmitting and receiving communication signals. The processor 210 can evaluate a power level of the battery during use of the first transceiver 206 and switch to the second transceiver 208 to transmit communications to a peer device within short range communication if the power level is below a predetermined threshold. For example, the first transceiver 206 can be a Wide Area Network (WAN) transceiver using high power consumption over a wide-area. The WAN transceiver can be used for primary communication such as private radio or cellular operation. The WAN transceiver is generally required to transmit and receive over wide areas that cover several kilometers. The WAN transceiver can therefore require a significant amount of power to support the transmitter and high sensitivity receiver components in order to meet the networks range requirement, such as communication coverage within at least one 1 kilometer.

The second transceiver 208 can be a Wireless Local Area Network (WLAN) or Personal Area Network (PAN) using low power consumption over a short-range providing communication coverage within at least 100 meters. The WLAN and PAN transceivers generally have much less power consumption due to the small range requirements of these networks such as 1-100 meters. The processor 210 can extend a battery life of the mobile device 102a by switching from the first transceiver 206 to the second low power transceiver 208 when the battery falls below a predetermined threshold. The mobile device 102 can communicate with a peer using a Bluetooth, ZigBee (Beacon mode), wireless USB, LP 802.11b/g, or magnetic induction technology to transmit and receive communication data from a base receiver.

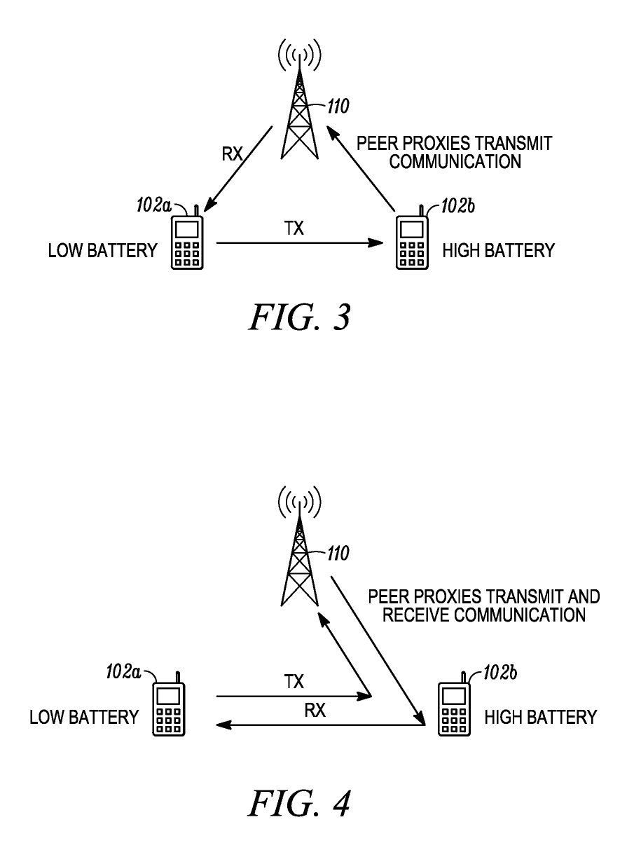

Referring to FIG. 3, a diagram of a first configuration for extending a battery life of a mobile device using a peer network is shown. Briefly, peers within short range communication of a mobile device 102 can be used as communication proxies if a power level of the mobile device 102 is low. For example, if the battery level of mobile device 102a drops below a predetermined threshold, the peer device 102b can be used to transmit communication data to the base receiver 110. That is, the mobile device 102a can request the peer to perform a transmit operation to the base receiver 110. In the first configuration shown, the peer 102b only performs a transmit communication to proxy the transmit communication of the mobile device 102a. The mobile device 102a can still receive communications signals from the base receiver 110. Notably, transmitting generally consumes more power than receiving due to sending the communication signal over long distances. A transmit signal is generally a high gain signal for increasing a signal to noise ratio of the transmitted communication signal. The base receiver 110 generally has sufficient power to transmit directly to the mobile device 102a. Accordingly, the mobile device 102a can receive communication data directly from the base receiver 110. In the first configuration shown in FIG. 3, the battery life of mobile device 102a can be extended when the peer 102b performs the high-power transmit operation.

Referring to FIG. 4, a diagram of a second configuration for extending a battery life of a mobile device using a peer network is shown. In the second configuration, the peer 102b can proxy both transmit and receive communications. That is, the peer 102b can transmit data from the mobile device 102a to the base receiver 110, and also forward data received from the base receiver 110 to the mobile device 102a. The peer 102b can proxy data from and to the mobile device to preserve a battery life of the mobile device 102a. For example, the mobile device 102a, upon determining a low battery level, can request the peer 102b to act as a transmit and receive proxy. The mobile device 102a can send communication data directly to the peer 102b, and the peer 102b can forward the communication data directly to the base receiver 110. The peer 102b can receive communication data directly from the base receiver 110, and the peer 102b can forward the communication data to the mobile device 102a. The peer 102b can communicate with the base receiver 110 using a high-power communication of the first transceiver 206 as shown in FIGS. 1 and 2. The mobile device 102a and the peer 102b can communicate over the WLAN 150 using a low-power communication of the second transceiver 208 as shown in FIGS. 1 and 2. Notably, the battery life of the mobile device 102a is extended since the peer 102b performs the high-power transmit and receive operation.

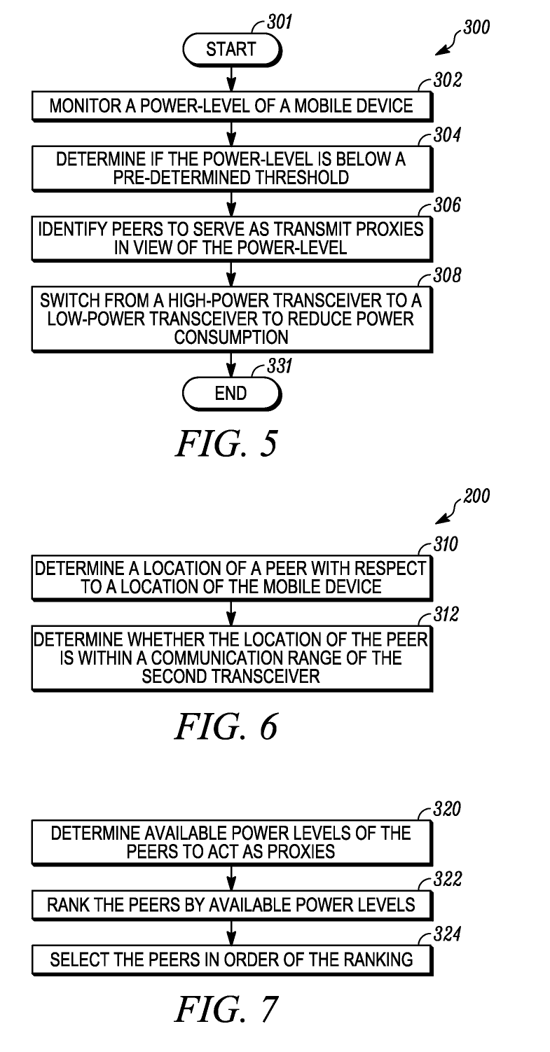

Referring to FIG. 5, a method 300 for extending a battery life of a mobile device using a peer network is shown. The method 300 can be practiced with more or less than the number of steps shown. To describe the method 300, reference will be made to FIGS. 1, 2, 6 and 7, although it is understood that the method 300 can be implemented in any other manner using other suitable components. In addition, the method 300 can contain more or less than the number of steps shown in FIG. 5.

At step 301, the method 300 can start. The method 300 can start in a state when the mobile device 102 is in power up mode, idle mode, in a voice call, or in a data communication mode. At step 302, a power-level of a mobile device can be monitored. The power-level identifies the longevity of the mobile device in providing communication. At step 304, a determination can be made if the power-level is below a pre-determined threshold. For example, referring back to FIG. 2, the monitor 204 can evaluate the power-level of the battery 202 and predict remaining power and usage rate to trigger a battery extension mode. Once in “battery extension” mode, the mobile device 102 can alert the WAN of the low battery trigger and request prioritization to seek and utilize nearby peers to transmit/receive payload by proxy. The payload can be voice, data, or both.

Returning back to FIG. 5, at step 306, peers can be identified to serve as transmit proxies in view of the power-level. A peer is a mobile device that is within short range communication of the mobile device. A proxy is a peer that can perform transmit and receive operations on behalf of the mobile device. As one example, referring to FIG. 6, at step 310, the mobile device 102a can determine a location of a peer with respect to a location of the mobile device. At step 312, the mobile device can determine whether the location of the peer is within a wireless communication range of the second transceiver. The location of the peers 102b can be transmitted to the mobile device 102a over a base receiver 110 in the mobile communication system 100 of FIG. 1. In another arrangement, the mobile device 102a can determine the presence of peers through peer-to-peer networking. For example, each mobile device can issue a beacon signal and await responses from other mobile devices in the wireless_local area network 150 (See FIG. 1).

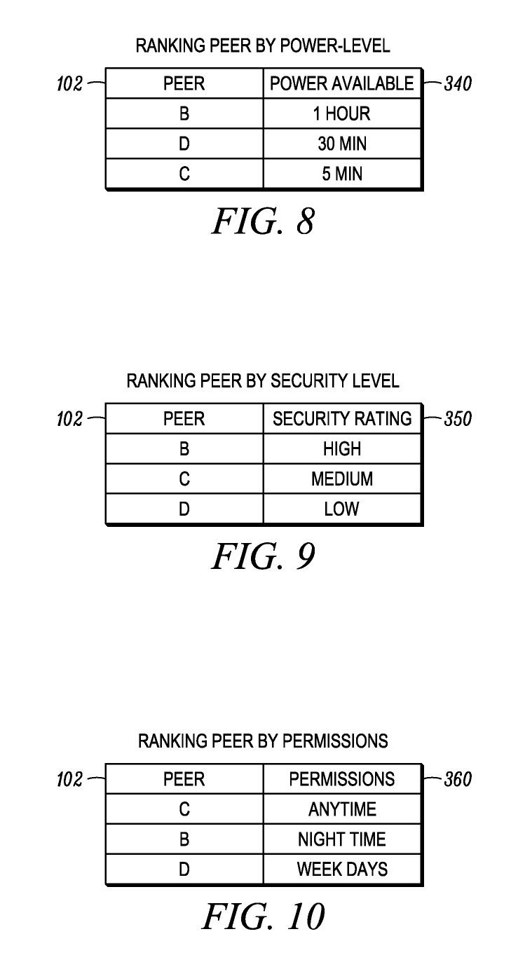

Upon identifying the peers that are within short-range communication of the mobile device 102a, the peers can be prioritized and ranked. In one arrangement, the peers can be ranked by available power level. For example, in FIG. 7, at step 320, available power levels of the peers to act as proxies can be determined. At step 322, the peers can be ranked by available power levels. And, at step 324, the peers can be selected in order of ranking. Referring to FIG. 8, an exemplary ranking of the peers by available power level 340 is shown. Notably, the peers with higher available power can be selected for extending the battery life of the mobile device 102a. As shown, peer 102b (B) has 1 hour of available power, peer 102d (D) has 30 minutes of available power, and peer 102c (C) has 5 minutes of available power. In another arrangement, the peers can be ranked by security level 350. For example, referring to FIG. 9, an exemplary ranking of the peers by security level is shown. In such regard, the peers with higher security rating can be selected as proxies. As shown, peer 102b (B) has high security level, peer 102c (C) has medium security level, and peer 102d (D) has low security level.

In yet another arrangement, the peers can be ranked by permission. For example, a peer may want to impose restrictions for allowing a mobile device to use the peer as a proxy. As an example, a peer may not want an unauthorized or unknown mobile device to utilize resources of the peer such as the battery power. Accordingly, the peer can assign permissions for allowing the peer to be used to extend another mobile device's battery life. The peer can also request a visual or auditory cue to identify when a mobile device is seeking permission, and any information associated with the mobile device or user of the mobile device. As one example, permissions can be signed to caller groups, individuals, organizations, companies, or individual people. For instance, a anytime grant permission can be provided to users on a same call group or on a friend list. A business grant permission can be provided to users in the same company or business. As yet another example, shown in FIG. 10, permissions can be granted based on the time of day. For instance, peer 102c (C) may grant permissions 360 anytime, peer 102b (B) may grant permissions only at night, and peer 102d (D) may grant permissions only on weekdays. Notably, the mobile device 102a can rank the peers 102b-d based on any combination of the arrangements identified. For example, the mobile device 102a can rank peers 102b-d based on a combination of available power level, security level, and permissions.

Returning back to FIG. 5, at step 308, upon identifying and ranking the peers, the mobile device 102a can switch from a high-power transceiver to a low-power transceiver to reduce power consumption. The mobile device 102a can then continue communication uninterrupted through the peer 102b. For example, upon determining a low-power level indicator, the processor 210 (See FIG. 2) can switch from the first transceiver (WAN) 206 to the second transceiver (WLAN or PAN) 208 to conserve power. Referring to FIG. 1, the mobile device 102a can switch communication over the RF link through the base receiver 110 in the WAN to the peer 102b in the WLAN through the access point 104. In such regard, the peer 102b provides transmit and receive operation over the WLAN 150 portion of the mobile communication system 100.

As an example, the mobile device 102a may be in a call with mobile device 102c over the RF link of the base receivers 110. The mobile device 102a uses the high-power WAN receiver 206 to communicate with the base receivers 110. Upon determining a low battery power-level, the mobile device 102a identifies peer 102b within the WLAN coverage area 150, and then establishes communication with the peer 102b. The peer 102b then proxies communication between mobile device 102a and mobile device 102c over the WLAN connection. The mobile device 102a employs the low-power WLAN transceiver 208 to communicate with the peer 102b thereby extending battery life of the mobile device 102a. Returning back to FIG. 5, at step 331, the method 300 can end.

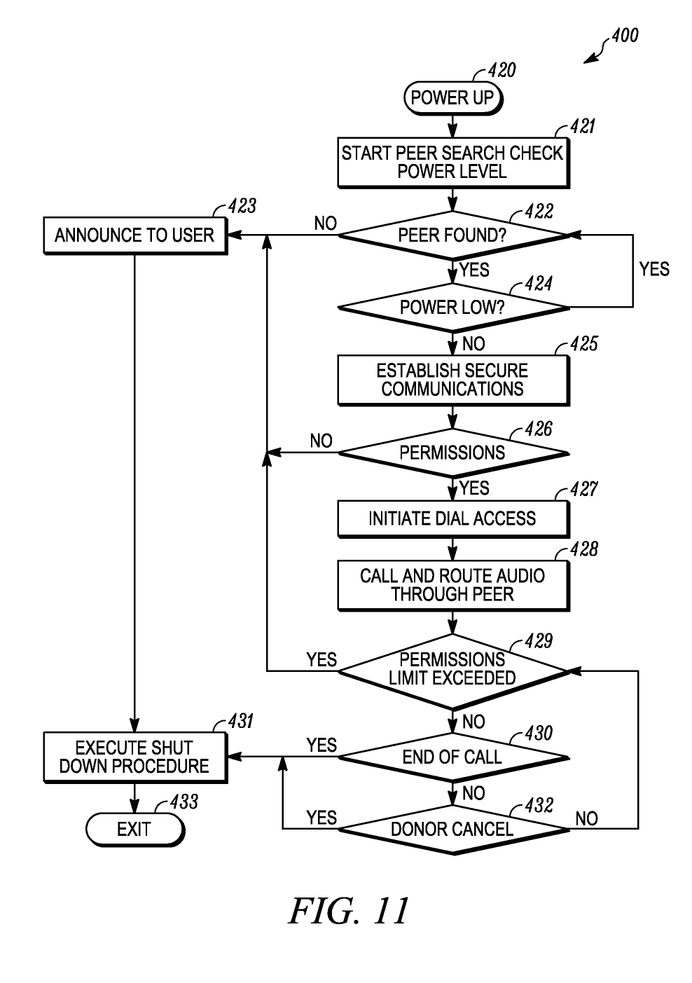

Referring to FIG. 11, an exemplary flow chart 400 for extending battery life of a mobile device in accordance with method 300 of FIG. 5 is shown. Notably, the steps of the flowchart 400 are not limited to the number of steps shown and can include more or less than those shown.

At step 420, the mobile device can power-up. Upon power-up, the mobile device 102a can receive calls, place phone calls, and communicate data, such as text messages, audio, or video. In the example of FIG. 11, the mobile device 102a attempts to make a call. At step 421, the mobile device 102a can start a peer search and check its own power level for making the call. If the power level of the mobile device 102a is low the mobile device 102a will search for a peer to serve as a proxy. If a peer is not found (422), an announcement can be made to the user that no peers are within short-range proximity (423). If a peer is found, the mobile device 102a can determine a power-level of the peer. Notably, the mobile device 102a assesses a battery power level of the peer to ensure that the peer is capable of serving as a proxy to the mobile device 102a. The mobile device 102a also evaluated its own battery level in step 421 to determine if it needs a peer to perform proxy services. Notably, the exemplary flow chart 400 identifies the steps the mobile device 102a performs when the mobile device 102a is low on battery power with regards to finding a peer to provide proxy services. If the battery level of the peer is below a predetermined threshold (424), the mobile device can continue to search for peers at step 422, and log peers that may be available at a later time for extending battery power when needed. If the power-level is above a predetermined threshold, the mobile device can establish secure communications with the identified peer (425) to make the call.

Recall, in FIGS. 8-10, that the mobile device 102a can prioritize the peers 102b-d by available power level, security level, and permission. Accordingly, at step 426, the mobile device determines if an identified peer grants permission of resources to the mobile device 102. In particular, the permission identifies whether the mobile device 102a can use the peer as a transmit or receive proxy. If the peer does not provide authorization to the mobile device, other peers can be evaluated for permission. Upon identifying a peer that grants resource permissions, the mobile device 102a can initiate dial access through the peer at step 427. That is, the mobile device 102a can perform call set-up or other communication functions through the peer 102b such as transmitting communication signals. Upon connecting the call, communication data can be routed at step 428 through the peer (such as mobile device 102b) to the mobile device 102a as shown in FIGS. 3 and 4.

If a permissions time limit is exceeded (429), a call shut down announcement is made at 423 and call shutdown procedure commences (431). That is, the peer terminates the call which ends the call for the mobile device 102a. In another arrangement, other peers can be identified for handing over the call prior to shut-down termination. In such regard, the call is not terminated and the call continues transparently from the perspective of the user. For example, the peer can limit a permission which informs the mobile device 102a to search for another peer (see 429). The peer 102b can continue to provide proxy services to the end of the call (430) if permissions are not limited. The peer 102b may limit permissions during the call which requires the mobile device 102a to source other peers for extending the battery life. For example, at step 432 the peer donating the resources may cancel permissions to the mobile device to start it's own phone call. The canceling of permissions by the donor peer can invoke a call-shut down procedure (431) which requires the mobile device to source other peers and requires a new call set-up procedure.

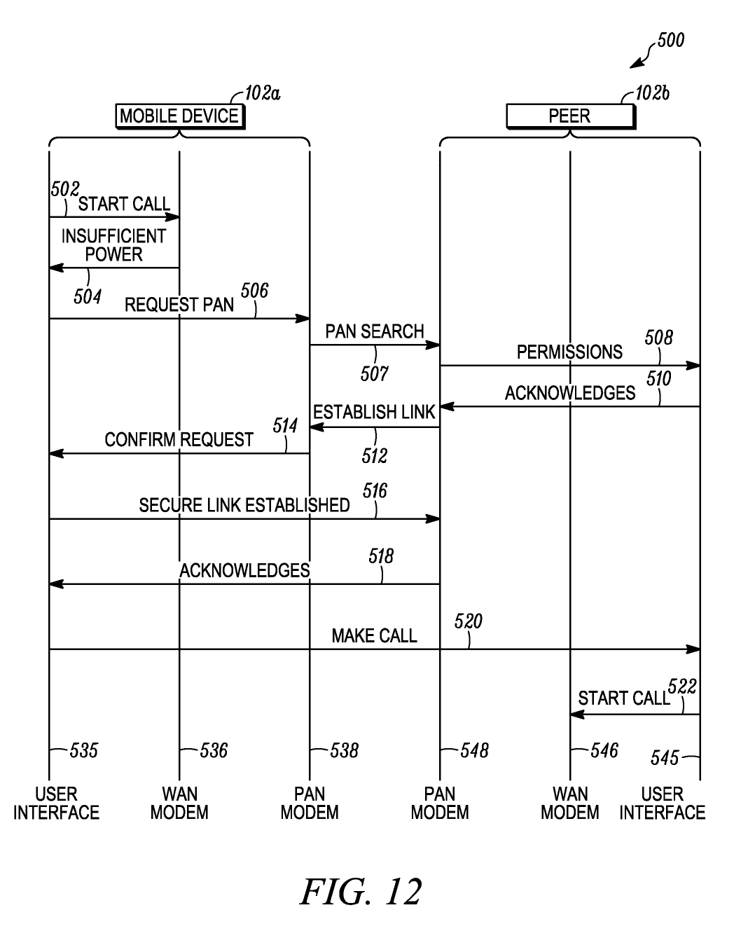

In FIG. 12, a flow diagram 500 for the communication between the mobile device 102a and the peer 102b is shown. The flow diagram 500 identifies the exchange of communication between the mobile device 102a and the peer 102b over a wide area network (WAN) and a personal area network (PAN) for practicing the steps of the flowchart 400 and the method 300. Briefly, the mobile device 102a contains a user interface 535, a WAN modem 536, and a PAN modem 538. The peer 102b also contains a user interface 545, a WAN modem 546, and a PAN modem 548. Notably, the WAN modem corresponds to the high-power first transceiver 206, and the PAN modem corresponds to the low-power second transceiver 208 as discussed in FIG. 2.

At step 502, the mobile device can start a call. The mobile device 102a uses the high power WAN modem 506 to place the call to one of the base receivers 110 shown in FIG. 1. Notably, the high-power WAN modem 506 is used since the communication signal is sent over long distances. At step 504, the mobile device 102a can determine if there is sufficient power to transmit the signal and make the call. For example, referring back to FIG. 3, the high-power first transceiver 206 (WAN) may require current drain that cannot be provided by the battery 202. The monitor 204 can assess the power level of the battery and determine if sufficient power is available to make the call. If there is insufficient power, the mobile device 102a can request use of the PAN network (506). At step 507, the PAN modem 538 can search for peers in short-range of the mobile device 102a. For example, the PAN modem 538 can transmit short-range communications signals to peers listening within an area of the mobile device 102a. Peers that are in range of the short-range communications signals can respond to the mobile device. Examples of short-range communication include Bluetooth, Zigbee, Ultra-Wide Band (UWB), or a IEEE 802.xx communication. As shown, peer 102b can receive the short-range communication signal and check for permissions of the mobile device 102a (508). For example, the peer 102b can receive information identifying the mobile device 102a and compare the information to permissions in a stored table. The information can be provided in audio or visual format through the user interface 545 of the peer. This allows a user of the peer device 102b to determine who is requesting resources permissions.

At step 510, the peer 102b can acknowledge user of resources and allow the peer 102b to serve as a transmit or receive proxy for the mobile device 102a. At step 512, the PAN link can be established between the mobile device 102a and the peer 102b. The PAN link is established between the PAN modem 538 and the PAN modem 548. This will allow the mobile device 102a to send and receive data through the peer 102b to the wide area network (WAN). At step 514, the request to use the peer 102b can be confirmed. For example, an auditory or visual indicator can be provided to the user through the user interface 535 to inform the user that a peer for extending battery life is available. At step 516, a secure link can be established between the mobile device 102a and the peer 102b. An acknowledgement can be provided at step 518 through the user interface 535 to inform the user that the call can be placed. At step 520, the user can place the call through the peer 102b. The peer device 102b can also provide a visual or auditory indicator that the call is in progress. This allows the peer device to monitor resource use and/or cancel permissions if necessary. At step 522, the peer 102b can place the call as a proxy through the WAN modem 546. Notably, the peer 102b uses the high-power WAN modem to make the call. In another arrangement, the peer 102b can source other peers to make the high-current drain call.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A system for utilizing peers to extend battery life of a mobile device, comprising:
a wireless infrastructure that provides communication coverage to mobile devices over a wide area;
at least one mobile device within the wireless infrastructure that switches from a high-power transceiver for communicating in the wireless infrastructure to a low-power transceiver for communicating with a peer when a power-level of a battery of the at least one mobile device falls below a predetermined threshold, and
a peer network communicatively coupled to the mobile device having at least one peer for providing proxy services to the mobile device when the power-level falls below the predetermined threshold.

2. The system of claim 1, wherein the cellular infrastructure identifies a location of peers within the peer network_using a location system and reports the location of the peers to the mobile device to identify peers available for serving as a proxy using low-power communication.

3. The system of claim 1, wherein peers within the peer network communicate amongst one another using low-power and low-range communication.

4. The system of claim 1, wherein at least one peer provides transmit wireless communication for the at least one mobile device.

5. The system of claim 1, wherein at least one peer provides receive wireless communication for the at least one mobile device.

6. The system of claim 1, wherein the low-power transceiver provides wireless communication up to one hundred (100) meters.

7. A mobile device having extended battery life capabilities, comprising:
a battery that provides power to the mobile device for transmitting and receiving communication signals;
a monitor operatively coupled to the battery that monitors a power level of the battery;
a first transceiver operatively coupled to the battery that provides long-range communication;
a second transceiver operatively coupled to the battery that provides short-range communication; and
a processor operatively coupled to the monitor, the first transceiver, and the second transceiver, that evaluates the power level and switches to the second transceiver to transmit communications to a peer device within short range communication if the power level is below a predetermined threshold.

8. The mobile device of claim 7, wherein the first transceiver is a Wide Area Network (WAN) transceiver using high power consumption over a wide-area providing coverage within at least one 1 kilometer.

9. The mobile device of claim 7, wherein the second transceiver is a Wireless Local Area Network (WLAN) transceiver or Personal Area Network (PAN) transceiver using low power consumption over a short-area providing wireless communication coverage within at least one hundred (100) meters.

10. The mobile device of claim 7, further comprising a location unit to identify a location of the mobile device.

11. A method for utilizing peer networks to extend battery life of a mobile device, the method comprising:
monitoring a power-level of the mobile device;
determining if the power-level is below a pre-determined threshold;
identifying peers to serve as transmit proxies in view of the power-level; and
switching from a high-power transceiver to a low-power transceiver to reduce power consumption,
wherein the mobile device communicates with the peers using the low-power transceiver to transmit communication data.

12. The method of claim 11, further comprising:
identifying peers to serve as receive proxies; and
receiving communication data from the peers.

13. The method of claim 11, wherein the step of identifying peers further includes
determining available power levels of the peers to act as transmit_proxies;
ranking the peers by available power levels; and
selecting the peers in order of the ranking.

14. The method of claim 11, wherein the step of identifying peers further includes
determining a location of a peer with respect to a location of the mobile device; and
determining whether the location of the peer is within a wireless communication range of the low power_transceiver.

15. The method of claim 11, further comprising
predicting a remaining power and usage rate from the power-level; and
triggering a battery extension mode based on the remaining power and usage rate.

16. The method of claim 15, further comprising:
requesting prioritization to seek and utilize peers to transmit or receive communication data by proxy; and
interrupting a peer if a priority communication is initiated.

17. The method of claim 11, further comprising providing an visual or auditory cue to indicate that a peer is providing proxy services to the mobile device.

18. The method of claim 11, further comprising prioritizing peers based on peer battery levels,
peer resource use, wide area network request, or wide area network rerouting.

19. The method of claim 11, further comprising prioritizing peers based on peer security.

20. The method of claim 11, further comprising dynamically selecting peers based on permissions of peers to serve as proxies for the mobile device.
